(19) United States
(12) Patent Application Publication
(10) Pub. No.: US 2026/0046728 A1
(43) Pub. Date: Feb. 12, 2026

(54) METHODS, ARCHITECTURES, APPARATUSES AND SYSTEMS FOR MANAGING PROTOCOL DATA UNIT SESSIONS FOR DUALSTEER CAPABLE DEVICES

(71) Applicant: InterDigital Patent Holdings, Inc., Wilmington, DE (US)

(72) Inventors: Anuj Sethi, Ottawa (CA); Rocco Di Girolamo, Laval (CA); Michael Starsinic, Newtown, PA (US); Guanzhou Wang, Brossard (CA); Taimoor Abbas, Sainte-Julie (CA); Magurawalage Chathura Madhusanka Sarathchandra, London (GB)

(21) Appl. No.: 18/798,565

(22) Filed: Aug. 8, 2024

(51) Int. Cl. H04W 36/22; H04W 28/02; H04W 60/04; H04W 76/10

(52) U.S. Cl. CPC H04W 36/22; H04W 28/0268; H04W 60/04; H04W 76/10

(57) ABSTRACT

Procedures, methods, architectures, apparatuses, systems, devices, and computer program products for establishing a PDU session by a WTRU that includes a first user equipment (UE) and a second UE, with a wireless network. The method includes causing the first UE to be registered, transmitting at least one first message including an identifier of the WTRU and a traffic switch preference parameter, receiving an indication that the PDU session is accepted and a traffic switch configuration, and communicating with the wireless network using the first UE and the first PDU session. The method further includes, based at least on the traffic switch configuration, causing the second UE to be registered, transmitting at least one second message including the identifier of the WTRU, receiving an indication of a second PDU session being accepted for the second UE, and communicating with the wireless network using the second UE and the second PDU session.

### BACKGROUND

The present disclosure is generally directed to the fields of communications, software and encoding, including, for example, to methods, architectures, apparatuses, systems related to managing Protocol Data Unit (PDU) Sessions for DualSteer capable devices.

### SUMMARY

In certain representative embodiments, a method or procedure, and related apparatuses for DualSteer traffic switch configuration is provided by the 5G Public Land Mobile Network (PLMN) to the DualSteer devices which will enable them to configure the registration and PDU session setup for a secondary User Equipment (UE) of each respective DualSteer device. This DualSteer traffic switch configuration provided by the 5G network functions (i.e., Access and Mobility management Function (AMF) and Session Management Function (SMF)) will be used by the DualSteer device to decide how to setup the PDU sessions and user plane paths for the secondary UE. For example, the DualSteer device may pre-establish the PDU sessions on both the third-generation partnership project (3GPP) access networks and only when the DualSteer device decides to switch the traffic to the second 3GPP access, the PDU session on the second 3GPP access is activated. As an alternate example, the secondary UE would (e.g., only) establish PDU sessions on the second 3GPP access after the decision has been made to switch the traffic to second 3GPP access through another Mobile Termination (MT) (e.g., from a primary UE to a secondary UE or from a secondary UE to a primary UE). The DualSteer traffic switch configuration may be determined based on a preference of the DualSteer UE with regard to the traffic switch for the secondary UE, along with other conditions (e.g., network load, traffic congestion, traffic type, and 3GPP access).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a dual MT model that may be used within the communications system illustrated in FIG. 1A;

FIG. 3 is a block diagram illustrating an example of a DualSteer device system using a non-roaming dual steering architecture, that may use the dual MT model of FIG. 2;

FIG. 4 is a block diagram illustrating an example of a DualSteer device system using a dual steering architecture with one roaming 3GPP access, where the system may use the dual MT model of FIG. 2;

FIG. 5 is a block diagram illustrating an example of a DualSteer device system using a dual steering architecture with two roaming 3GPP accesses with a common Visitor PLMN (VPLMN), where the system may use the dual MT model of FIG. 2;

FIG. 6 is a block diagram illustrating an example of a DualSteer device system using a dual steering architecture with two roaming 3GPP accesses, each of which has a respective Visitor PLMN (VPLMN), where the system may use the dual MT model of FIG. 2;

FIG. 7 is a procedure for the registration of UEs and PDU session management that may be implemented using the communications system illustrated in FIG. 1A; and

FIG. 8 is a flowchart of an illustrative process for establishing a protocol data unit (PDU) session with a wireless network, which may be implemented using the communications system illustrated in FIG. 1A.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

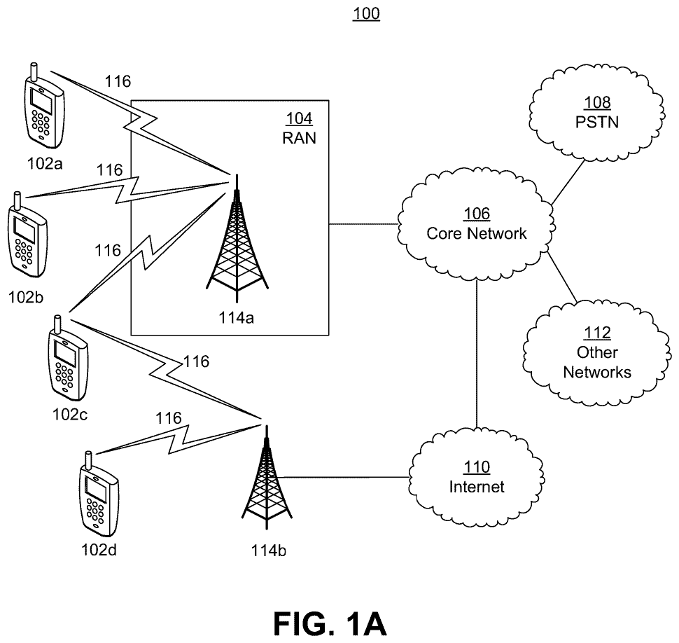

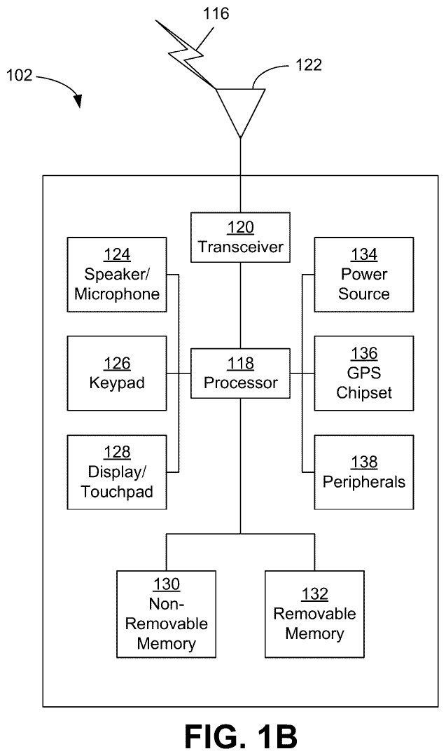

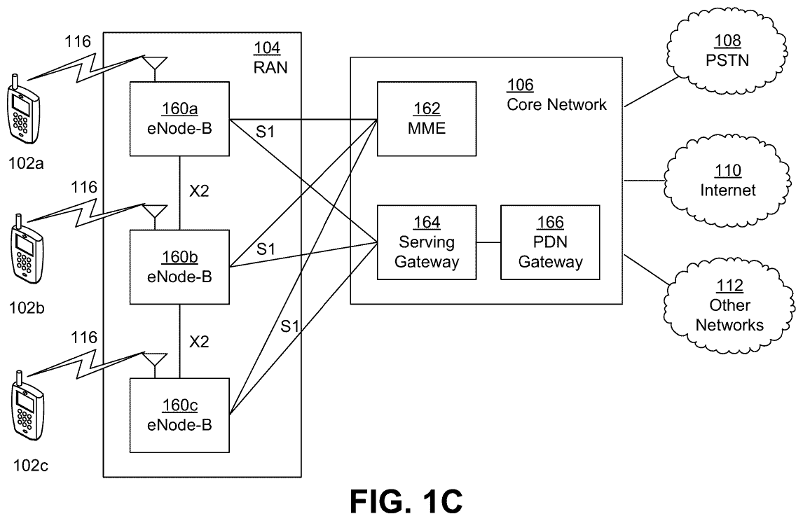

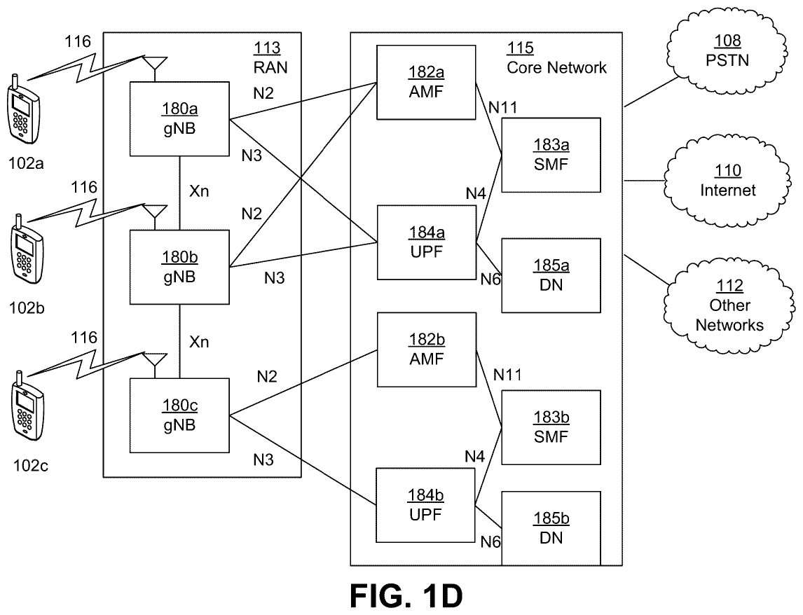

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a UE, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an evolved Node-B (eNB), a Home Node-B (HNB), a Home eNode-B (HeNB), a next generation Node-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation (CA) technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management (MM), and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

### Session and Mobility Management

WTRUs (e.g., WTRUs 102a, 102b, 102c, 102d) may provide both their Session Management (SM) and MM capability to the core network 106/115. A WTRU may send the WTRU MM Core Network Capability information to the AMF (e.g., AMFs 182a, 182b) during the Initial Registration procedure and Mobility Registration Update procedure, the WTRU MM Core Network Capability information sent within a NAS message. Further, a WTRU (e.g., WTRUs 102a, 102b, 102c, 102d) may include its respective 5G Session Management (5GSM) Core Network Capability in PDU Session Establishment/Modification Requests. Each PDU Session Establishment/Modification Request may include the respective WTRU's Access Traffic Steering, Switching and Splitting (ATSSS) capabilities.

In certain respective embodiments, WTRUs 102a, 102b, 102c, 102d perform registration to a network when accessing services requiring registration. In some embodiments, the WTRU performs a method to perform this registration, the method including PLMN selection or Standalone Non-Public Network (SNPN) selection, cell selection and/or reselection, and registration. The selection of a PLMN or a SNPN may be performed by the WTRU in order to select a mobile network. The mobile network may be any suitable public network or non-public network (NPN). In some embodiments, the WTRU (e.g., WTRU 102a, 102b, 102c, 102d) follows rules on how to select from the available mobile networks at a given location, and to determine when to look for higher priority networks. The cell selection and reselection processes may include the WTRU “camping”, or idling, on a cell. In some embodiments, the WTRU may reselect to enter an idle mode once one of the cell selection process or reselection process is complete. The WTRU may perform the registration by informing the mobile network of the WTRU's presence, and provide some (e.g., course) location information, capability exchange and negotiations.

Splitting traffic across two 3GPP access legs

In some examples, CA is provided over a single 3GPP access (e.g., NR or LTE), but allows the WTRU to receive over two or more cells, such that each cell is on a different frequency carrier. In some embodiments, the use of the two cells is managed in the RANs 104/113.

In some implementations, WTRUs 102a, 102b, 102c, 102d may also support DC. DC allows a WTRU to receive and transmit over two 3GPP accesses (or 3GPP access legs). The accesses may be NR (e.g., when using gNBs) or LTE (e.g., when using eNBs). For a 5G system (5GS), an initial deployment had a first leg over LTE and a second leg over NR. However, current deployments of DC also support two legs over NR. In such cases, the two legs may be on two different bands (e.g., a first frequency and a second frequency). For a WTRU that uses DC, the RF front end should support each access. When a WTRU uses DC, one access leg is a master leg, and the other leg is a secondary leg. In some embodiments, the master leg is one of at least two master legs of a Master Cell Group (MCG), and the secondary leg is one of at least two secondary legs of a Secondary Cell Group (SCG). In implementations which use PLMN and/or NPNs, each of the networks can be managed by a same operator or by different operators.

Traffic steering and switching over two 3GPP access networks 3GPP supports mechanisms that enable traffic steering, switching and splitting between a 3GPP access network (e.g., Evolved UMTS Terrestrial Radio Access (E-UTRA) or NR) and a non-3GPP access network (e.g., Wi-Fi). One example of such mechanisms is the ATSSS feature. 3GPP also includes mechanisms to support traffic steering and switching over two 3GPP access networks by using devices which are compatible with multi-access steering, switching, and splitting (MASSS), or DualSteer.

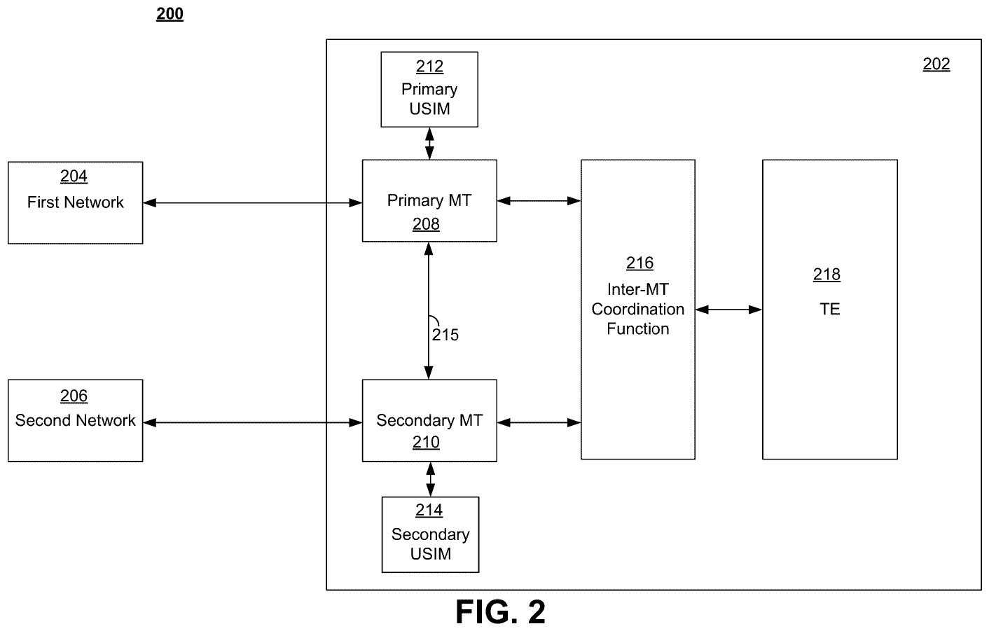

A DualSteer device may be defined as a device that supports traffic steering and switching of user data across two 3GPP access networks. A DualSteer device may be any suitable WTRU with DualSteer capabilities. In certain respective embodiments, the DualSteer device is one of: (a) a single WTRU, in the case of non-simultaneous data transmission over the two networks, and (b) two separate WTRUs in the case of simultaneous data transmission over the two networks. Each DualSteer device may correspond to a subscriber for the DualSteer device, where the subscriber of the DualSteer device has two subscriptions and/or Subscription Permanent Identifiers (SUPIs), sharing one subscription profile from the same operator of the access network (AN). For any particular service, at any given time, the DualSteer device may transmit all traffic of that service using (e.g., only) a single 3GPP access network. In some implementations, a DualSteer device can be defined using different models, e.g., a model that includes two separate Control Plane/User Plane (CP/UP) stacks with an additional DualSteer Control Layer within a single MT block. Similarly, in some implementations, a dual-MT device model may include a dual-MT device with two separate MTs and two separate USIMs, with each MT providing functionalities that are in a MT of a WTRU, such as radio transmission/reception, baseband signal processing, access to USIM, and CP/UP stacks. There may be an internal inter-MT interface between the two MTs, where the inter-MT interface enables the two MTs to exchange information between each other. Alternatively, the two MTs may exchange information through an Inter-MT Coordination Function (IMCF) layer. Each of the two MTs may be identified by a respective unique device identifier such as an International Mobile Equipment Identity (IMEI). There are various implementations of the two 3GPP access types (e.g., NR, Non-Terrestrial NR, E-UTRA) and the network types (e.g., Home PLMN (H-PLMN), Visitor PLMN (V-PLMN), and PNI-NPN) to which the 3GPP access networks are connected. In certain representative embodiments, for purposes of DualSteer, a single WTRU (e.g. 102, 202 (FIG. 2)), may include two UEs in which each UE includes at least a respective MT and a respective USIM.

A device may be considered DualSteer capable when it meets at least one of the following conditions: (1) the device uses two SUPIs from the same operator for accessing two separate 3GPP access networks and each SUPI is used to connect to (e.g., only) one of the 3GPP access networks, (2) the device may send its user data over two 3GPP access networks that belong to the same PLMN, where the user data is either sent non-simultaneously or simultaneously, and (3) the device may send its user data over two 3GPP access networks that belong to two different PLMNs, where the user data is either sent non-simultaneously or simultaneously. In implementations of non-simultaneous data transmission over two networks, the DualSteer device may be a single WTRU. In implementations of simultaneous data transmission, the DualSteer device may include two separate WTRUs. In certain respective embodiments that perform simultaneous data transmission, the data over two separate networks should belong to different services or different Service Data Flows (SDFs). At any given point of time, (e.g., all) traffic of a single service may be sent over a single access network, therefore the WTRU does not perform service data splitting.

### WTRU Identities

The SUPI is a 5G globally unique identifier allocated to each subscriber. The SUPI value is provisioned in the Universal Subscriber Identity Module (USIM) and the Unified Data Management (UDM) and/or User Data Repository (UDR) function in a 5G Core. The SUPI may be an International Mobile Subscriber Identifier (IMSI) or a Network Access Identifier (NAI). In implementations that include the IMSI version of the SUPI, the first three digits of the SUPI represent the Mobile Country Code (MCC), the next two or three digits of the SUPI represent the Mobile Network Code (MNC), identifying the network operator or PLMN, and the remaining digits of the SUPI represent the Mobile Subscriber identification number (MSIN).

A Subscription Concealed Identifier (SUCI) is a privacy-preserving identifier including a concealed SUPI. In some embodiments, the SUCI includes a PLMN ID of a home network, the PLMN ID including an MCC and MNC. In certain respective embodiments, the MCC and the MNC are transmitted in plain text.

A 5G Globally Unique Temporary Identifier (GUTI) is allocated by the AMF (e.g., AMF 182a, 182b). In certain respective embodiments, the AMF (e.g., AMF 182a, 182b) may assign a new 5G-GUTI to the WTRU at any time. The 5G-GUTI includes a Globally Unique AMF ID (GUAMI) and a 5G Temporary Mobile Subscriber Identity (TMSI), where the GUAMI identifies the assigned AMF and the 5G-TMSI identifies the WTRU uniquely within the AMF (e.g., AMF 182a, 182b). In some embodiments, the GUAMI is defined by a concatenation of the PLMN ID and the AMF identifier.

### Multi-USIM (MUSIM) Operation

In certain respective embodiments. a WTRU may have multiple USIMs that are in operation simultaneously, where each USIM allows the WTRU to obtain service from a different mobile network. An example use case for MUSIM devices is for professionals who use a business number and a separate personal number. In such an example, instead of carrying two devices (e.g. phones), these professionals use a single device with two USIMs.

A terminal behavior of handling multiple USIMs simultaneously that may arise depends on the WTRU capabilities. Some example WTRUs include (1) a WTRU with a single receiver (Rx) and a single transmitter (Tx), (2) a WTRU with a dual Rx and a single Tx, and (3) a WTRU with a dual Rx and a dual Tx. In some implementations, each dual Rx enables a MUSIM WTRU to simultaneously receive traffic from two networks, each single Rx enables a MUSIM WTRU to receive traffic from one network at one time, and each single Tx allows a MUSIM WTRU to transmit traffic to one network at one time.

In some embodiments, the two USIMs of a MUSIM device run independently of each other. In some implementations, the WTRU has dedicated NAS and Access Stratum protocol stacks for each USIM of the two USIMs. However, depending on the capabilities of the WTRU, some coordination may be implemented to allow the WTRU to obtain service from both mobile networks. This coordination does not rely on MN interactions and therefore the WTRU acts as a mediator between the two MNs.

Herein, a subscription to two network operators through a MUSIM device is designated as a “dual subscription”, while each subscription to a network operator, not involving a MUSIM device is designated as a “single subscription”.

### Inter-PLMN Mobility

In certain respective embodiments, the AMF (e.g., AMF 182a, 182b) uses the N14 interface for AMF re-allocation and AMF to AMF information transfer. The N14 interface may be implemented as either intra-PLMN or inter-PLMN (e.g., in the case of inter-PLMN mobility). In some embodiments, a handover procedure may allow for inter-PLMN mobility, the handover procedure including a source AMF that may select at least one AMF instance in a target PLMN by querying target PLMN level Network Repository Function (NRF) via the source PLMN level NRF with a target PLMN ID. The target PLMN level NRF then returns an AMF instance address based on a target operator configuration. Once the handover procedure is complete the source AMF may then select a different target AMF.

### Dual-MT Device Model

FIG. 2 shows Dual-MT device model 200 with Dual-MT device 202 which may include two separate Mobile Terminations (MTs) (e.g., a primary MT 208 and a secondary MT 210) and two separate USIMs (e.g., a primary USIM 212 and a secondary USIM 214). Each MT (e.g., primary MT 208 and secondary MT 210) provides functionalities that are in an MT of a WTRU, such as radio transmission/reception, baseband signal processing, access to a USIM, and CP/UP stacks. In some implementations of Dual-MT device 202, there may be a common Terminal Equipment (TE) 218 (as shown in FIG. 2) or two separate TEs (not shown in FIG. 2) where each of the two separate TEs correspond to one of the two MTs (e.g., primary MT 208 and secondary MT 210). In certain respective embodiments, Dual-MT device 202 may include an internal inter-MT interface 215 between each of the two MTs (e.g., primary MT 208 and secondary MT 210), where the inter-MT interface 215 allows the two MTs (e.g., primary MT 208 and secondary MT 210) to exchange information between each other. Alternatively, the two MTs (e.g., primary MT 208 and secondary MT 210) may exchange information through an IMCF layer 216. Each respective MT of the primary MT 208 and secondary MT 210 may be identified by a respective unique device identifier such as an IMEI. In other embodiments, an additional ID called a DualSteer specific WTRU ID (DS-specific-WTRU-ID) may be used to interlink primary MT 208 and secondary MT 210 in dual-MT device 202.

Each of the primary MT 208 and secondary MT 210 has a separate subscription for registering to mobile network, such as a first network 204 or a second network 206. In some embodiments, primary MT 208 may register to a PLMN at first, and the secondary MT 210 may register (e.g., only) when it is triggered by the primary MT 208 directly or via the IMCF 216. In addition, a WTRU in a DualSteer capable device may include the information of primary MT 208 or secondary MT 210 as part of the WTRU Registration Request message and send it to a network.

A device that uses MASSS, or DualSteer, supports traffic steering and switching of user data for different services across two 3GPP access networks. In some implementations, a DualSteer device may send its user data over two 3GPP access networks belonging to the same PLMN or different PMLNs, where the user data is either sent non-simultaneously or simultaneously.

For cases of traffic switching between the primary MT 208 (e.g., a primary WTRU) and secondary MT 210 (e.g., a secondary WTRU) there are various implementations for setting up of the PDU sessions and user plane paths. In some implementations, the dual-MT device 202 may pre-establish the PDU sessions on both the access networks (e.g., first network 204 and second network 206) and (e.g., only) when dual-MT device 202 (e.g., DualSteer device) decides to switch the traffic to the second access network (e.g., second network 206), the PDU session on the second access network (e.g., second network 206) is activated. These implementations may lead to a greater signaling load, which may result pre-emptively determining the switching decision which is not needed. In some alternate implementations, the secondary MT 210 (e.g., secondary WTRU) would (e.g., only) establish PDU sessions on the second access network (e.g., second network 206) after a decision has been made, by dual-MT device 202, to switch the traffic to the second access network (e.g., second network 206) via another MT, such as the primary MT 208. Similarly, primary MT 208 (e.g., primary WTRU) may establish PDU sessions on the first access network (e.g., first network 204) after a decision has been made, by dual-MT device 202, to switch the traffic to the first access network (e.g., first network 204) via another MT, such as the secondary MT 210. These alternate implementations may require additional time to setup the N3 tunnel and a first MT may not be able to access the same SMF which is handling the PDU session on the other access network associated with a second MT of the dual-MT device 202, which may result in switching failures or unexpected delays.

These implementations for a DualSteer device (e.g., dual-MT device 202), along with others provided herein, may result in smoother switching and reduced overall service interruptions, while taking into consideration a dynamic network environment and ensuring operational efficiency for each entity included in the 5G mobile system.

DualSteer device Architecture

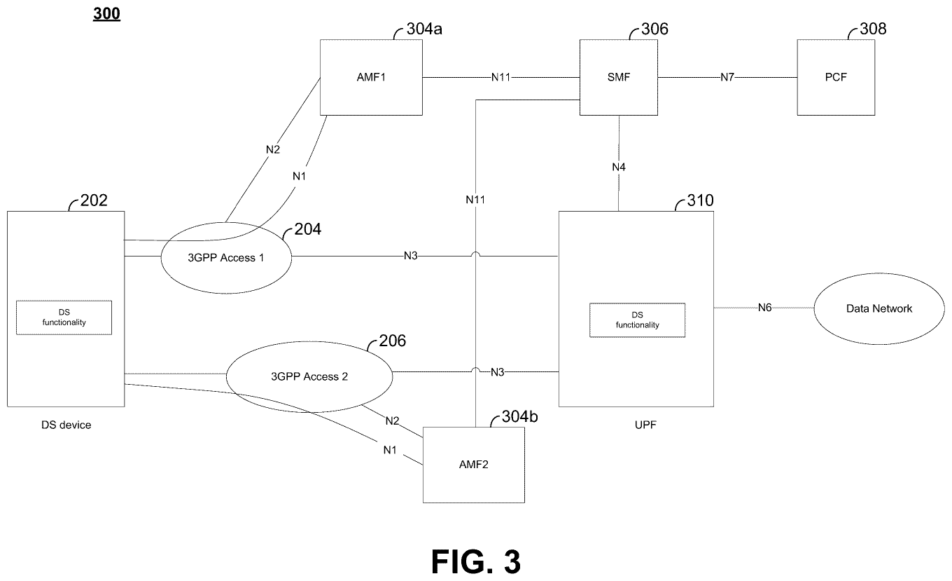

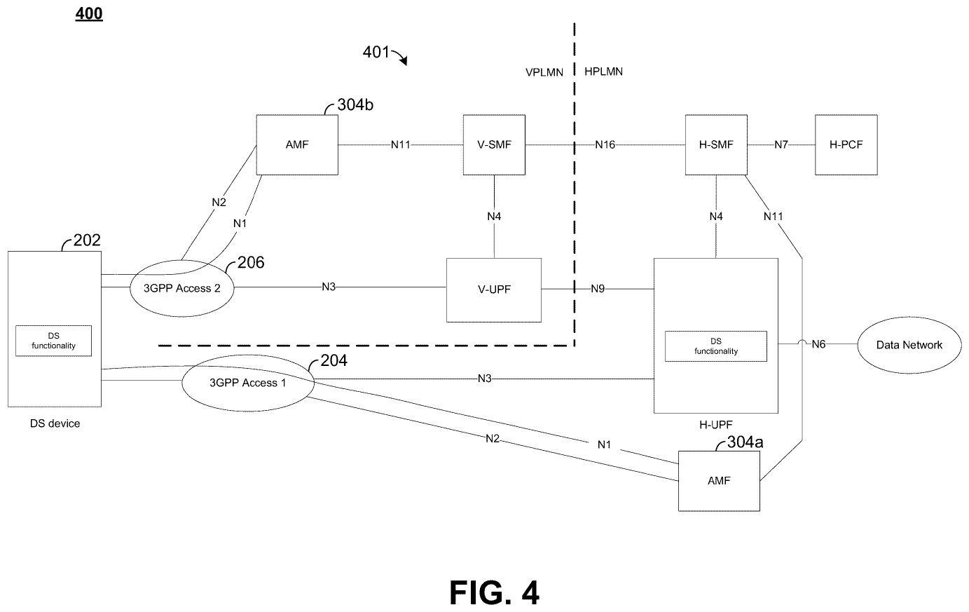

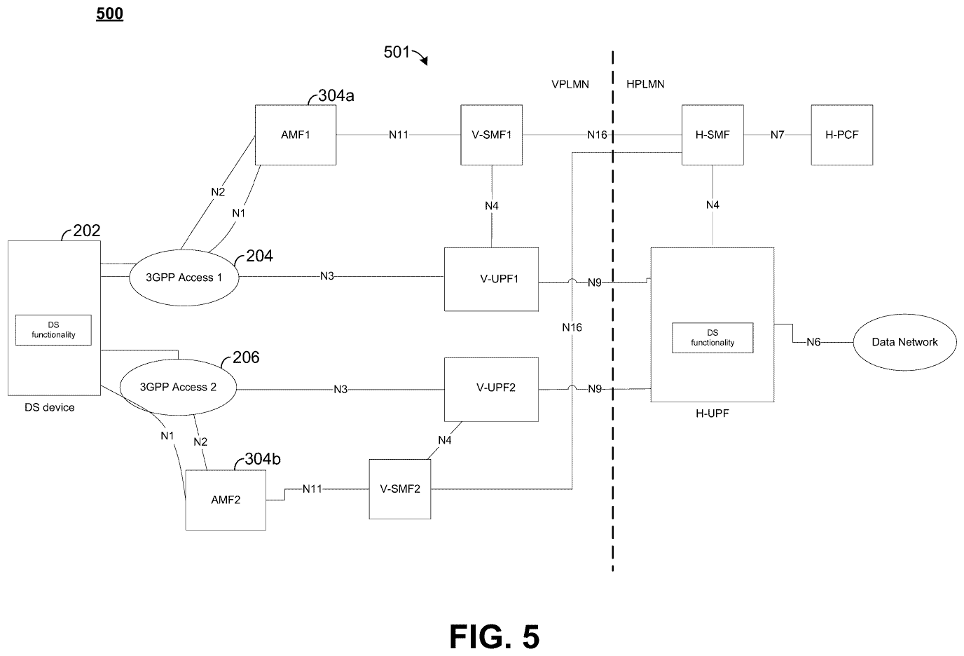

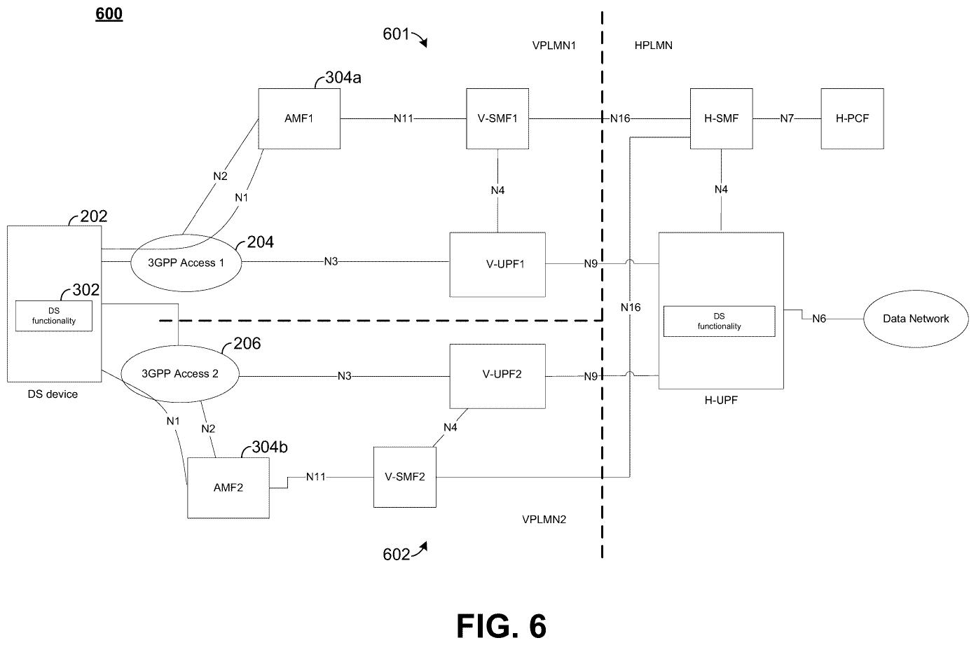

The architectures of the network systems (e.g., 300, 400, 500, and 600) disclosed herein may each provide a common User Plane Function (UPF) (e.g., UPF 310) which acts as a common anchor and an SMF (e.g., SMF 306) inside the 5G Core (5GC) Architecture for the DualSteer traffic from both 3GPP access networks (e.g., first network 204 and second network 206). In some implementations, the architectures (e.g., 300, 400, 500, and 600) may include a non-roaming 3GPP access and/or a roaming 3GPP access. FIG. 3 shows an example of a DualSteer device system 300 using a non-roaming dual steering architecture. FIG. 4 shows an example of a DualSteer device system 400 using a dual steering architecture with one roaming 3GPP access 401. FIG. 5 shows an example of a DualSteer device system 500 using a dual steering architecture with two roaming 3GPP accesses with a common Visitor PLMN (VPLMN) 501. FIG. 6 shows an example of a DualSteer device system 600 using a dual steering architecture with two roaming 3GPP accesses, each of which has a respective VPLMN (e.g., first VPLMN 601 and second VPLMN 602).

For a DualSteer capable device with two WTRUs, one of the two WTRUs may be designated as a primary WTRU (e.g., primary MT 208) and the other as a secondary WTRU (e.g., secondary MT 210). The common DualSteer specific WTRU ID, e.g., DS-specific-WTRU-ID, may be used to interlink the primary WTRU (e.g., primary MT 208) and the secondary WTRU (e.g., secondary MT 210) at an initial registration or a PDU session establishment to network. The common DualSteer specific WTRU ID may also be used to associate the respective PDU sessions of the primary WTRU (e.g., primary MT 208) and the secondary WTRU (e.g., secondary MT 210). The DualSteer specific WTRU ID may be provided by: (1) determining, at the IMCF layer (e.g., IMCF 216), the DualSteer specific WTRU ID based on the application or service being used and provided to the WTRUs (e.g., primary MT 208 and secondary MT 210), (2) configuring, by a network function (NF), e.g., AMF or PCF during a Mobility Registration procedure, the DualSteer specific WTRU ID in one of the primary WTRU (e.g., primary MT 208) and secondary WTRU (e.g., secondary MT 210) and then the Dual specific WTRU ID is internally exchanged to the other one of the primary WTRU (e.g., primary MT 208) and secondary WTRU (e.g., secondary MT 210), (3) pre-configuring the DualSteer specific WTRU ID in the DualSteer capable device, and (4) providing the DualSteer specific WTRU ID by an application in one of the WTRU (e.g., one of the primary MT 208 and the secondary MT 210) or an application server over the application layer (user plane).

For the PDU session establishment a DualSteer device (e.g., dual-MT device 202) may (e.g., only) have the primary WTRU (e.g., primary MT 208) registered to the network, and the secondary WTRU registration is triggered based on an internal trigger for PDU session establishment for the secondary WTRU (e.g., secondary MT 210). In alternative implementations, each of the primary WTRU (e.g., primary MT 208) and the secondary WTRU (e.g., secondary MT 210) may have registered to the network but (e.g., only) primary WTRU (e.g., primary MT 208) establishes a PDU session at first, and the secondary WTRU (e.g., secondary MT 210) waits for a trigger from the primary WTRU (e.g., primary MT 208) for the PDU session establishment. In some implementations, both WTRUs (e.g., primary MT 208 and secondary MT 210) perform simultaneous registrations and a respective PDU session is established for each of the WTRUs (e.g., primary MT 208 and secondary MT 210) at the same time, but each of the WTRUs (e.g., primary MT 208 and secondary MT 210) use the common ID (e.g., DualSteer specific WTRU ID) as part of PDU session establishment procedure so the network may identify that the PDU sessions for each of the primary WTRU and secondary WTRU are linked to the same device (e.g., dual-MT device 202).

### Registration and Pdu Session Procedure for Dualsteer Device

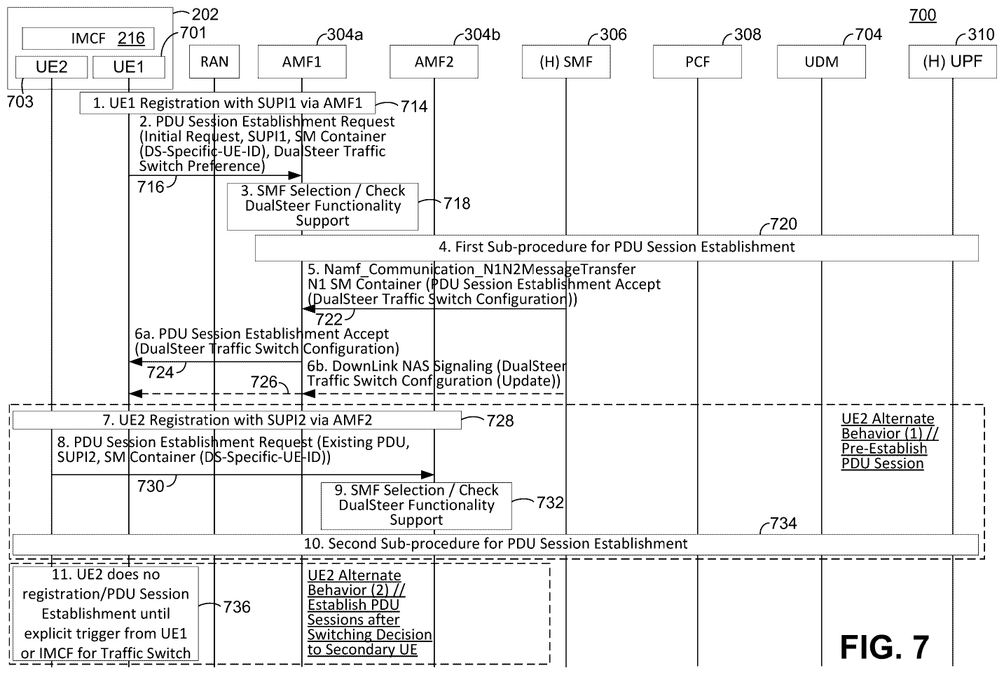

FIG. 7 shows a procedure 700, or method, for the registration and PDU session establishment of DualSteer devices (e.g., dual-MT device 202) using a new information element provided by the 5G, i.e., DS Traffic Switch configuration. This new information element may be used by the DualSteer device (e.g., dual-MT device 202) to decide how to setup the PDU sessions and user plane paths for the secondary WTRU (e.g., secondary UE 703). In some implementations, the procedure includes pre-establishing the PDU sessions on both the access networks (e.g., 3GPP access legs) and (e.g., only) when the DualSteer device (e.g., dual-MT device 202) decides to switch the traffic to the second access associated with the secondary WTRU (e.g., secondary UE 703), the PDU session on the second access is activated. In alternative implementations, the secondary WTRU (e.g., secondary UE 703) would (e.g., only) establish PDU sessions on the second access after the decision has been made, by the DualSteer device (dual-MT device 202), to switch the traffic to the second access via the primary WTRU (e.g., primary UE 701).

At step 714, the primary UE 701 registers to 5GC through primary AMF 304a using a primary SUPI as the subscription identifier. The registration may be performed over a 3GPP access with a certain type of connectivity (e.g., Radio Access Technology (RAT) type, such as LTE, NR, non-terrestrial; and frequency band).

At step 716, the primary UE 701 sends a PDU Session Establishment request with a Request Type initial request using the primary SUPI, the request including a DS-specific-WTRU-ID parameter in a mobility management (MM) part as well as in a N1 SM container. In some implementations the DS-specific-WTRU-ID is generated by the DualSteer device (e.g., dual-MT device 202) and may uniquely identify the DualSteer PDU Session across both UEs (e.g., primary UE 701 and secondary UE 703). In some implementations, the primary UE 701 may include additional parameters, such as a traffic switch preference (e.g., a DS Traffic Switch Preference). The traffic switch preference provides, to the DualSteer device (e.g., dual-MT device 202), a preference with respect to the setup of the PDU session and user plane path on the secondary UE 703 when switching traffic among the primary UE 701 and the secondary UE 703. The traffic switch preference parameter (e.g., DS Traffic Switch Preference) may be a value that corresponds to one of the following preferences: (1) pre-establishing the PDU session on the secondary UE 703 is preferred, and (2) pre-establishing the PDU session on the secondary UE 703 is not preferred.

The determination of the traffic switch preference parameter (e.g., DS Traffic Switch Preference) by the DualSteer device (e.g., dual-MT device 202) may be based on a traffic type being requested by the DualSteer device (e.g., dual-MT device 202) on the primary UE 701. For example, if the traffic type is IP based, the traffic switch preference (e.g., DS Traffic Switch Preference) may be set to prefer the pre-establishment of the PDU session on the secondary UE 703. As an alternate example, when the traffic type is Ethernet based, the DualSteer device (e.g., dual-MT device 202) may set the traffic switch preference to not prefer the pre-establishment of the PDU session on the secondary UE 703. In another alternative example, the determination of the traffic switch preference may be based on a priority of the traffic (i.e., high priority and normal priority), or may also be based on whether the traffic has a guaranteed bit rate (GBR), i.e. GBR traffic or non-GBR traffic.

In some implementation, the determination of the traffic switch preference parameter (e.g., DS Traffic Switch Preference) may be based on a type of connectivity for the primary UE 701. For example, the DualSteer device (e.g., dual-MT device 202) may prefer to pre-establish a PDU session when the primary UE 701 is connected via LTE and may prefer to not pre-establish the PDU session when the primary UE 701 is connected via NR. As another example, the DualSteer device (e.g., dual-MT device 202) may prefer pre-establishment of PDU sessions when primary UE 701 is connected via a non-terrestrial access network or when using an unlicensed frequency band.

The determination of the traffic switch preference parameter (e.g., DS Traffic Switch Preference) may be based on one or more IP address preservation requirement received from the application layer. If the application requires IP address preservation, the traffic switch preference parameter may be determined to prefer a pre-establishment of a PDU session. Similarly, when no IP address preservation is required for an application, the traffic switch preference parameter (e.g., DS traffic switch preference) may be determined to prefer to not pre-establish a PDU session.

In some implementations, the determination of the traffic switch preference parameter (e.g., DS Traffic Switch Preference) may be based on a user preference or based on with the same HPLMN, Equivalent HPLMN (EHPLMN), or Equivalent PLMN (ePLMN), or roaming on different VPLMNs. This determination may be based on radio capabilities of one or more of the primary UE 701 and secondary UE 703. For example, when the DualSteer device (e.g., dual-MT device 202) has a dual Receiver-Transceiver (Rx-Tx) configuration (i.e., the DualSteer device is capable of simultaneous transmission) the DualSteer device (e.g., dual-MT device 202) may determine that the traffic switch preference parameter indicates a preference for the pre-establishment of PDU sessions. In an alternative scenario, if the radio capabilities of the DualSteer device include dual Rx and a single Tx (i.e., the DualSteer device is capable of non-simultaneous transmission), the DualSteer device (e.g., dual-MT device 202) may determine that the traffic switch preference parameter that does not prefer pre-establishment of PDU sessions.

Alternatively, in some implementations, the wireless network may retrieve the traffic switch preference parameter (e.g., DS Traffic Switch Preference) from the application server (AS). Information about the AS may be retrieved from subscription information stored in the UDM and/or UDR for the DualSteer device (e.g., dual-MT device 202). The DualSteer device may retrieve this information by using an identifier of the DualSteer device (i.e., DS-specific-WTRU-ID).

At step 718, the primary AMF 304a selects an SMF (e.g., SMF 306) that supports the DualSteer functionality of DualSteer device (e.g., dual-MT device 202). For example, the SMF 306 selected by the primary AMF 304a is aware of the DualSteer devices (e.g., dual-MT device 202), recognizes that these DualSteer devices are identified using DS-specific-WTRU-IDs, and that established PDU sessions using either of the primary UE 701 or the secondary UE 703 are correlated to each other.

At step 720, a first sub-procedure for PDU session establishment is performed. The first sub-procedure may include the following steps. First, an SM Context message (e.g., a Nsmf_PDUSession_CreateSMContext Request or a Nsmf_PDUSession_UpdateSMContext Request) is transmitted from primary AMF 304a to SMF 306. In some implementations, if SM Subscription data for corresponding SUPI, Data Network name (DNN) and Single - Network Slice Selection Assistance Information (S-NSSAI) of the network (e.g., a HPLMN) is not available, then SMF 306 may retrieve the SM Subscription data (e.g., using a Nudm_SDM_Get signal) and may subscribe to be notified when this subscription data is modified (e.g., using a Nudm_SDM_Subscribe signal). In some implementations, UDM 704 may retrieve this information from UDR (e.g., using a Nudr_DM_Query signal) and may subscribe to notifications from UDR for the same data (e.g., by using a Nudr_DM_subscribe signal. A response signal (e.g., either an Nsmf_PDUSession_CreateSMContext Response signal or an Nsmf_PDUSession_UpdateSMContext Response signal) may then be transmitted from SMF 306 to primary AMF 304a. In some implementations of the first sub-procedure, a secondary authentication or authorization of the first PDU session is performed. If dynamic policy and charging control (PCC) is to be used for the first PDU Session, the SMF 306 performs PCF 308 selection. The SMF 306 may perform an SM Policy Association Establishment procedure to establish an SM Policy Association with the PCF 308 and retrieve default PCC Rules for the first PDU session. When the request type of the SM Context message indicates an initial request, the SMF 306 selects a service and session continuity (SSC) mode for the first PDU session. The SMF 306 may also select one or more UPFs (e.g., UPF 310) as needed. SMF 306 may further perform an SMF initiated SM Policy Association Modification procedure to provide information on the Policy Control Request Trigger conditions that have been met. If the request type of the SM context message indicates an initial request, the SMF 306 initiates an N4 Session Establishment procedure with the selected UPFs (e.g., UPF 310). Otherwise, the SMF 306 initiates an N4 Session Modification procedure with the selected UPFs (e.g., UPF 310). In some implementations, SMF 306 transmits an N4 Session Establishment/Modification Request to the UPF 310 and provides packet detection, enforcement and reporting rules to be installed on the UPF 310 for the first PDU Session. UPF 310 then acknowledges the receipt of the N4 Session Establishment/Modification Request from SMF 306 by transmitting an N4 Session Establishment/Modification Response.

At step 722, SMF 306 sends a message (e.g., Namf_Communication_N1N2MessageTransfer message) to the primary AMF 304a, the message containing a N1 SM Container (i.e., a PDU Session Establishment Accept message) along with a traffic switch configuration (e.g., DS Traffic switch configuration). The traffic switch configuration (e.g., DS Traffic switch configuration) contains information indicative of a first traffic switch behavior or information indicative of a second traffic switch behavior. The first switch behavior may correspond to a traffic switch preference parameter that indicates a preference to pre-establish a PDU session for the secondary UE 703. The second switch behavior may correspond to a traffic switch preference parameter that indicates a preference to not pre-establish a PDU session for the secondary UE 703. The traffic switch configuration may be used by DualSteer device (e.g., dual-MT device 202) when performing the setup of the second PDU session and user plane path for the secondary UE 703.

The traffic switch configuration (e.g., DS Traffic switch configuration) may include a value that indicates one of the of the following: (1) the pre-establishment of the PDU sessions on the secondary UE 703 is allowed, (2) the pre-establishment of the PDU sessions on the secondary UE 703 is not allowed, and (3) the pre-establishment of the PDU sessions on the secondary UE 703 is mandated. In some implementations when the DualSteer device (e.g., dual-MT device 202) is configured to always maintain two PDU sessions for certain data flows, the traffic switch configuration may include a value which indicates that the pre-establishment of the PDU sessions on the secondary UE 703 is mandated.

In some implementations, the determination of the traffic switch configuration (e.g., DS Traffic switch configuration) may be based on one or more of: (1) a configuration stored in the AMF 304a/SMF 306 subscription data for the DualSteer device (e.g., dual-MT device 202), (2) dynamic conditions that are indicative of network congestion (e.g., traffic congestion) and overload, traffic type (i.e., IP traffic, Ethernet traffic), (3) information from the PCF 308 for the requesting DualSteer device (e.g., dual-MT device 202) identified with identifier DS-specific-WTRU-ID, (4) the traffic switch preference parameter (e.g., DS Traffic Switch Preference) provided by the DualSteer device (e.g., dual-MT device) during the registration or PDU session establishment procedure, and (5) DualSteer device radio capabilities (i.e., support for dual Rx/Tx configuration or dual Rx and single Tx configuration). In addition, the determination of the traffic switch configuration (e.g., DS Traffic switch configuration) may be based on one or more QoS requirements for the QoS flows to be transported on the PDU session. For example, when QoS flows require smooth DualSteer switching, the SMF 306 may determine to set the traffic switch configuration (e.g., DS Traffic switch configuration) to indicate that the pre-establishment of the PDU sessions on the secondary UE 703 is allowed.

In some implementations, the network functions (AMF 304a or SMF 306) may use the identifier, DS-specific-WTRU-ID, to retrieve information about the secondary UE subscription from one of the UDM 704 or UDR. This secondary UE subscription information may be used in the determination of the traffic switch configuration (e.g., DS Traffic switch configuration). The traffic switch configuration may be determined using the secondary UE subscription information when, for example, the primary UE 701 and the secondary UE 703 share the same PLMNs or ePLMNs or are subscribed to completely different PLMNs with no correlation present. When traffic from both of the primary UE 701 and the secondary UE 703 may be routed via the same SMF 306/UPF 310, the traffic switch configuration (e.g., DS Traffic switch configuration) may be determined to indicate that the pre-establishment of the PDU sessions on the secondary UE 703 is allowed.

At step 724, the primary AMF 304a transmits the PDU session establishment accept message to the DualSteer device (e.g., dual-MT device 202). The PDU session establishment accept message includes the determined traffic switch configuration (e.g., DS Traffic switch configuration). In some implementations, the determined traffic switch configuration may be transmitted by the network via other NAS DL signal messages.

At step 726, the network (e.g., primary AMF 304a/SMF 306) may transmit an update for the traffic switch configuration (e.g., DS traffic switch configuration) to the DualSteer device (e.g., dual-MT device 202). In some implementations, the update for the traffic switch configuration may enable and/or disable one of the possible configuration values, or switch configuration values. The network (e.g., primary AMF 304a/SMF 306) may transmit the update as a NAS MM DL signal (i.e., a configuration update command message) or a NAS SM DL signal (i.e., a PDU Session Modification Command message). After receiving an updated traffic switch configuration (e.g., updated DS traffic switch configuration) the DualSteer device (e.g., dual-MT device 202) may perform either a (1) registration/PDU session establishment procedure or (2) de-registration/PDU Session release, for the secondary UE 703 based on updated configuration values of the updated traffic switch configuration. For example, if the updated traffic switch configuration (e.g., DS traffic switch configuration) includes configuration values which indicate that a pre-establishment of the PDU sessions on the secondary UE 703 is allowed, and if the secondary UE 703 is not already registered and does not have any PDU sessions established, the DualSteer device (e.g., dual-MT device 202) may trigger the registration and PDU session establishment on the secondary UE 703.

At step 728, the secondary UE 703 registers to 5GC architecture through a secondary AMF 304b using a secondary SUPI as the subscription identifier. In some implementations, the primary AMF 304a and secondary AMF 304b may belong to one of: (1) a same HPLMN, (2) an HPLMN and an eHPLMN, (3) an HPLMN and an eVPLMN, (4) an HPLMN and an VPLMN and/or (5) any suitable combination of VPLMNs.

At step 730, the secondary UE 703 sends a PDU session establishment request to the secondary AMF 304b. In some implementations, the PDU session establishment request includes information associated with the existing PDU Session and includes the identifier (e.g., DS-specific-WTRU-ID) in an MM part of the request as well as in the SM container.

At step 732, the identifier (e.g., DS-specific-WTRU-ID) included in the MM part of the request may be used by the secondary AMF 304b in the SMF 306 selection process. In some implementations, the secondary AMF 304b may use the identifier (e.g., DS-specific-WTRU-ID) in the AMF subscription data to determine the primary SUPI, which is associated with the DualSteer device (e.g., dual-MT device 202). In some implementations, the secondary AMF 304b may use the primary SUPI to retrieve the SMF 306 context and may select the same SMF used by primary AMF 304a and common anchor UPF 310 based on the identifier of the dual-MT device 202 (e.g., DS-specific-WTRU-ID).

At step 734, a second sub-procedure for PDU session establishment is performed. The second sub-procedure may include the following steps. First, an SM Context message (e.g., a Nsmf_PDUSession_CreateSMContext Request or a Nsmf_PDUSession_UpdateSMContext Request) is transmitted from secondary AMF 304b to SMF 306. In some implementations, if SM Subscription data for corresponding SUPI, Data Network name (DNN) and Single - Network Slice Selection Assistance Information (S-NSSAI) of the network (e.g., a HPLMN) is not available, then SMF 306 may retrieve the SM Subscription data (e.g., using a Nudm_SDM_Get signal) and may subscribe to be notified when this subscription data is modified (e.g., using a Nudm_SDM_Subscribe signal). In some implementations, UDM 704 may retrieve this information from UDR (e.g., using a Nudr_DM_Query signal) and may subscribe to notifications from UDR for the same data (e.g., by using a Nudr_DM_subscribe signal. A response signal (e.g., either an Nsmf_PDUSession_CreateSMContext Response signal or an Nsmf_PDUSession_UpdateSMContext Response signal) may then be transmitted from SMF 306 to secondary AMF 304b. In some implementations of the second sub-procedure, a secondary authentication or authorization of the second PDU session is performed. If dynamic policy and charging control (PCC) is to be used for the second PDU Session, the SMF 306 performs PCF 308 selection. The SMF 306 may perform an SM Policy Association Establishment procedure to establish an SM Policy Association with the PCF 308 and retrieve default PCC Rules for the second PDU session. When the request type of the SM Context message indicates an initial request, the SMF 306 selects a service and session continuity (SSC) mode for the second PDU session. The SMF 306 may also select one or more UPFs (e.g., UPF 310) as needed. SMF 306 may further perform an SMF initiated SM Policy Association Modification procedure to provide information on the Policy Control Request Trigger conditions that have been met. If the request type of the SM context message indicates an initial request, the SMF 306 initiates an N4 Session Establishment procedure with the selected UPFs (e.g., UPF 310). Otherwise, the SMF 306 initiates an N4 Session Modification procedure with the selected UPFs (e.g., UPF 310). In some implementations, SMF 306 transmits an N4 Session Establishment/Modification Request to the UPF 310 and provides packet detection, enforcement and reporting rules to be installed on the UPF 310 for the second PDU Session. UPF 310 then acknowledges the receipt of the N4 Session Establishment/Modification Request from SMF 306 by transmitting an N4 Session Establishment/Modification Response. SMF 306 may then transmit a message transfer (e.g., Namf_Communication_N1N2MessageTransfer) to secondary AMF 304b. In some implementations, second PDU session is successfully established with the common SMF 306 and anchor UPF 310. The second PDU session on the secondary UE 703 may (e.g., optionally) be established without activating UP resources. In some implementations, UP resources may be activated once the DualSteer device (e.g., dual-MT device 202) determines to switch the traffic from the primary UE 701 to the secondary UE 703.

At step 736, pre-establishment of the PDU sessions on the secondary UE 703 is not allowed as per the received traffic switch configuration (e.g., DS Traffic switch configuration), at 722, and accordingly the secondary UE 703 does not cause to register or perform PDU session establishment procedure until a triggering event is received (e.g., a trigger signal, such as a traffic switch signal). As an alternative implementation, the secondary UE 703 may self-register to a second network, however, the secondary UE 703 will refrain from establishing any PDU sessions until and unless the secondary UE 703 receives a triggering event (e.g., trigger signal) from IMCF 216 or via primary UE 701. The triggering event may be received by secondary UE 703 based on a decision by the primary UE 701 to switch traffic to the secondary UE 703.

Alternatively, the traffic switch configuration (e.g., DS Traffic switch configuration) may be received by the secondary UE 703 during the registration procedure on the secondary UE 703, at step 728. The secondary UE 703 may determine, based at least on the received traffic switch configuration (e.g., DS Traffic switch configuration), whether pre-establishing the second PDU session with the secondary UE 703 for the traffic switch is preferred or not preferred. In some implementations, when pre-establishing the second PDU session with the secondary UE 703 is not preferred, the secondary UE 703 may wait to receive a triggering event from the primary UE 701 to establish the second PDU session.

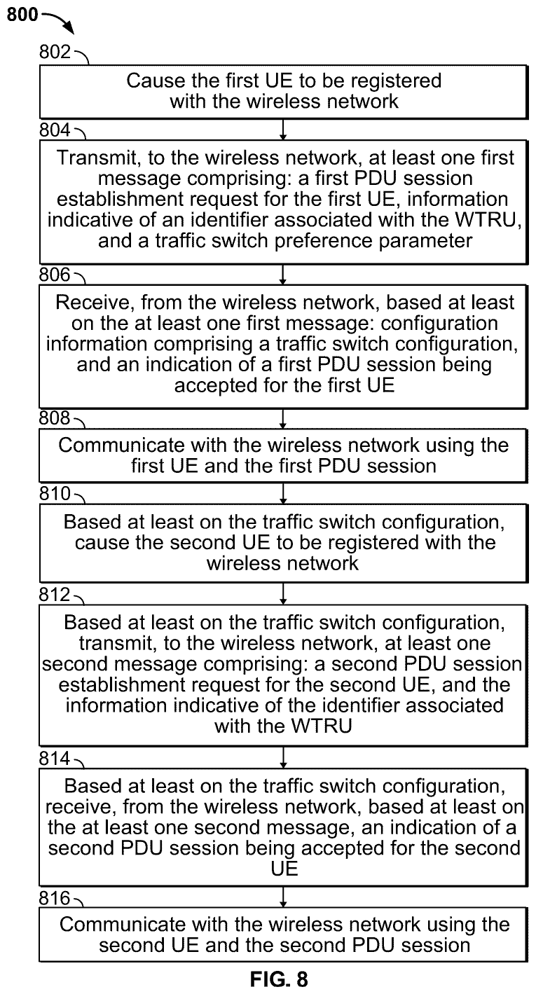

FIG. 8 shows a flowchart of an illustrative process 800 for establishing a PDU session with a wireless network, which may be implemented using the communications system 100 illustrated in FIG. 1A.

At 802, the WTRU causes the first UE to be registered with the wireless network.

At 804, the WTRU transmits, to the wireless network, at least one first message including (1) a first PDU session establishment request for the first UE, (2) information indicative of an identifier associated with the WTRU, and (3) a traffic switch preference parameter.

At 806, the WTRU receives, from the wireless network, based at least on the at least one first message configuration information including a traffic switch configuration, and an indication of a first PDU session being accepted for the first UE.

At 808, the WTRU communicates with the wireless network using the first UE and the first PDU session.

At 810, the WTRU causes the second UE to be registered with the wireless network based at least on the traffic switch configuration.

At 812, the WTRU transmits, to the wireless network, at least one second message including a second PDU session establishment request for the second UE and the information indicative of the identifier associated with the WTRU, based at least on the traffic switch configuration.

At 814, based at least on the traffic switch configuration, the WTRU receives, from the wireless network, an indication of a second PDU session being accepted for the second UE based at least on the at least one second message.

At 816, the WTRU communicates with the wireless network using the second UE and the second PDU session.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a RF transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶ 6 or means-plus-function claim format, and any claim without the terms “means for” is not so intended.

What is claimed is:

1. A method, performed by a wireless transmit/receive unit (WTRU), for establishing a protocol data unit (PDU) session with a wireless network, the WTRU comprising a first user equipment (UE) and a second UE, the method comprising:
causing the first UE to be registered with the wireless network;
transmitting, to the wireless network, at least one first message comprising: a first PDU session establishment request for the first UE, information indicative of an identifier associated with the WTRU, and a traffic switch preference parameter;
receiving, from the wireless network, based at least on the at least one first message: configuration information comprising a traffic switch configuration, and an indication of a first PDU session being accepted for the first UE; and
communicating with the wireless network using the first UE and the first PDU session;
based at least on the traffic switch configuration:
causing the second UE to be registered with the wireless network,
transmitting, to the wireless network, at least one second message comprising: a second PDU session establishment request for the second UE, the information indicative of the identifier associated with the WTRU, and
receiving, from the wireless network, based at least on the at least one second message, an indication of a second PDU session being accepted for the second UE; and
communicating with the wireless network using the second UE and the second PDU session.

2. The method according to claim 1, wherein the traffic switch preference parameter comprises a value indicative of whether establishment of the second PDU session on the second UE prior to a triggering event is preferred or not preferred.

3. The method according to claim 1, the method further comprising determining the traffic switch preference parameter based on at least one of a traffic type, a priority of the traffic, whether the traffic has a guaranteed bit rate (GBR), a connectivity type for the first UE, one or more IP address preservation requirements, one or more user preferences, or whether each of the first UE and the second UE are sharing a mobile subscription over the wireless network.

4. The method according to claim 1, the method further comprising retrieving the traffic switch preference parameter from an application server communicatively coupled to the WTRU.

5. The method according to claim 1, wherein the traffic switch configuration is indicative of a first traffic switch behavior, and the method further comprises:
in response to receiving the at least one first message and based on the traffic switch configuration:
causing the second UE to be registered with the wireless network;
transmitting, to the wireless network, at least one second message comprising: a second PDU session establishment request for the second UE, the information indicative of the identifier associated with the WTRU; and
receiving, from the wireless network, based at least on the at least one second message, an indication of a second PDU session being accepted for the second UE.

6. The method according to claim 1, wherein the traffic switch configuration is indicative of a second traffic switch behavior, and the method further comprises, based on the second traffic switch behavior, while communicating with the wireless network using the first UE and the first PDU session, receiving a triggering event indicating a traffic switch; and
in response to receiving the triggering event indicating the traffic switch:
causing the second UE to be registered with the wireless network;
transmitting, to the wireless network, the at least one second message; and
receiving, from the wireless network, the indication of the second PDU session being accepted for the second UE.

7. The method according to claim 1, wherein the traffic switch configuration is determined, by the wireless network, based on one or more of the traffic switch preference parameter, traffic congestion, and traffic type.

8. The method according to claim 1, wherein:
causing the first UE to be registered with the wireless network comprises causing the first UE to be registered with the wireless network by using a first access leg;
causing the second UE to be registered with the wireless network comprises causing the second UE to be registered with the wireless network by using a second access leg; and
the wireless network comprises two roaming access networks and at least one Visitor Public Land Mobile Networks (VPLMNs), wherein each VPLMN of the at least one VPLMNs is used by at least one of the two access networks.

9. The method according to claim 1, wherein the second UE has been deregistered from the wireless network and the second PDU session has been released for the second UE, and the method further comprising:
receiving, from the wireless network, updated configuration information comprising an updated traffic switch configuration;
based at least on the updated traffic switch configuration:
causing the second UE to be registered with the wireless network;
transmitting, to the wireless network, at least one third message comprising: a third PDU session establishment request for the second UE and the information indicative of the identifier associated with the WTRU; and
receiving, from the wireless network, based at least on the at least one third message, an indication of a third PDU session being accepted for the second UE; and
communicating with the wireless network using the second UE and the third PDU session.

10. The method according to claim 1, further comprising:
receiving, from the wireless network, updated configuration information comprising an updated traffic switch configuration; and
based at least on the updated traffic switch configuration:
causing the second UE to be deregistered with the wireless network;
transmitting, to the wireless network, at least one third message comprising: a PDU session release request for the second UE and the information indicative of the identifier associated with the WTRU; and
receiving, from the wireless network, based at least on the at least one third message, an indication of the second PDU session being released for the second UE.

11. A wireless transmit/receive unit (WTRU) comprising:
a first user equipment (UE);
a second UE; and
processing circuitry, wherein the WTRU is to:
cause the first UE to be registered with a wireless network,
transmit, to the wireless network, at least one first message comprising: a first PDU session establishment request for the first UE, information indicative of an identifier associated with the WTRU, and a traffic switch preference parameter,
receive, from the wireless network, based at least on the at least one first message: configuration information comprising a traffic switch configuration, and an indication of a first PDU session being accepted for the first UE;
communicate with the wireless network using the first UE and the first PDU session;
based at least on the traffic switch configuration:
cause the second UE to be registered with the wireless network;
transmit, to the wireless network, at least one second message comprising: a second PDU session establishment request for the second UE, the information indicative of the identifier associated with the WTRU; and
receive, from the wireless network, based at least on the at least one second message, an indication of a second PDU session being accepted for the second UE; and
communicate with the wireless network using the second UE and the second PDU session.

12. The WTRU of claim 11, wherein the traffic switch preference parameter comprises a value indicative of whether establishment of the second PDU session on the second UE prior to a triggering event is preferred or not preferred.

13. The WTRU of claim 11 is further to determine the traffic switch preference parameter based on at least one of a traffic type, a priority of the traffic, whether the traffic has a guaranteed bit rate (GBR), a connectivity type for the first UE, one or more IP address preservation requirements, one or more user preferences, or whether each of the first UE and the second UE are sharing a mobile subscription over the wireless network.

14. The WTRU of claim 11 is further to retrieve the traffic switch preference parameter from an application server communicatively coupled to the WTRU.

15. The WTRU of claim 11, wherein the traffic switch configuration is indicative of a first traffic switch behavior, and the WTRU is further to:
in response to the receipt of the at least one first message and based on the traffic switch configuration:
cause the second UE to be registered with the wireless network;
transmit, to the wireless network, at least one second message comprising: a second PDU session establishment request for the second UE, the information indicative of the identifier associated with the WTRU; and
receive, from the wireless network, based on the at least one second message, an indication of a second PDU session being accepted for the second UE.

16. The WTRU of claim 11, wherein the traffic switch configuration is indicative of a second traffic switch behavior, and while the WTRU communicates with the wireless network using the first UE and the first PDU session, the WTRU is to, based on the traffic switch configuration indicative of the second traffic switch behavior, receive a triggering event indicating a traffic switch; and
in response to the receipt of the triggering event indicating the traffic switch:
cause the second UE to be registered with the wireless network;
transmit, to the wireless network, the at least one second message; and
receive, from the wireless network, the indication of the second PDU session being accepted for the second UE.

17. The WTRU of claim 11, wherein the traffic switch configuration is determined, by the wireless network, based on one or more of the traffic switch preference parameter, traffic congestion, and traffic type.

18. The WTRU of claim 11, wherein:
to cause the first UE to be registered with the wireless network the WTRU is to cause the first UE to be registered with the wireless network by using a first access leg;
to cause the second UE to be registered with the wireless network the WTRU is to cause the second UE to be registered with the wireless network by using a second access leg; and
the wireless network comprises two roaming access networks and at least one Visitor Public Land Mobile Networks (VPLMNs), wherein each VPLMN of the at least one VPLMNs is used by at least one of the two access networks.

19. The WTRU of claim 11, wherein the second UE has been deregistered from the wireless network and the second PDU session has been released for the second UE, and the WTRU is further to:
receive, from the wireless network, updated configuration information comprising an updated traffic switch configuration;
based at least on the updated traffic switch configuration:
cause the second UE to be registered with the wireless network;
transmit, to the wireless network, at least one third message comprising: a third PDU session establishment request for the second UE and the information indicative of the identifier associated with the WTRU; and
receive, from the wireless network, based at least on the at least one third message, an indication of a third PDU session being accepted for the second UE; and
communicate with the wireless network using the second UE and the third PDU session.

20. The WTRU of claim 11 is further to:
receive, from the wireless network, updated configuration information comprising an updated traffic switch configuration; and
based at least on the updated traffic switch configuration:
cause the second UE to be deregistered with the wireless network;
transmit, to the wireless network, at least one third message comprising: a PDU session release request for the second UE and the information indicative of the identifier associated with the WTRU; and
receive, from the wireless network, based at least on the at least one third message, an indication of the second PDU session being released for the second UE.
